(19) United States
(12) Patent Application Publication
(10) Pub. No.: US 2026/0261068 A1
(43) Pub. Date: Sep. 3, 2026

(54) CONNECTOR AND CONNECTOR ASSEMBLY

(71) Applicant: SUMITOMO WIRING SYSTEMS, LTD., Mie (JP)

(72) Inventor: Masanori HIROTA, Mie (JP)

(21) Appl. No.: 18/863,643

(22) PCT Filed: Apr. 28, 2023
(86) PCT No.: PCT/JP2023/016827

§ 371 Date: Nov. 7, 2024

(30) Foreign Application Priority Data
May 17, 2022 (JP) 2022-080711

(51) Int. Cl. H01R 13/424

(52) U.S. Cl. CPC H01R 13/424

(57) ABSTRACT

A connector includes a plurality of terminals, a housing including a plurality of terminal accommodating portions for accommodating the terminals, the terminal accommodating portions being arranged in parallel in a width direction, and a retainer for retaining the terminals in the terminal accommodating portions. The housing is formed with a mounting hole communicating with the plurality of terminal accommodating portions, the retainer being mounted into the mounting hole, and a first recess disposed between the terminal accommodating portions adjacent in the width direction and recessed rearward from a front surface of the housing. The first recess includes a front recess penetrating through the housing in a front-rear direction from the front surface of the housing to a front end of the mounting hole and a rear recess extending further rearward than a rear end of the mounting hole.

### TECHNICAL FIELD

The present disclosure relates to a connector and a connector assembly.

### BACKGROUND

Conventionally, a connector is known which retains terminal fittings accommodated into a connector housing by a retainer. The connector housing of this connector is provided with cavities capable of accommodating the terminal fittings and a retainer mounting portion communicating with the insides of the cavities from outside the connector housing, and the retainer mounted into the retainer mounting portion enters the cavities, locks the terminal fittings and retains the terminal fittings.

A connector of this type may be used in oil such as lubricating oil in which foreign matters such as iron powders float. In such a case, the foreign matters such as iron powders may, for example, intrude into the connector housing through a gap between the connector housing and the retainer or the like and short-circuit terminal fittings accommodated in adjacent cavities.

Accordingly, for example, in a connector described in Patent Document 1 below, the following measure is taken to suppress a short circuit of terminal fittings due to contamination of foreign matters. A plurality of cavities are provided side by side in a row in a connector housing of this connector, and a retainer mounting portion is provided below the cavities. Extension walls are provided to project on lower sides of separation walls partitioning between the adjacent cavities. In this way, a distance (creepage distance) of a path from one terminal fitting, out of the adjacent terminal fittings, to the other terminal fitting along the wall surface on the lower side is extended to suppress a short circuit between the terminal fittings due to contamination of foreign matters.

### PRIOR ART DOCUMENT

### Patent Document

Patent Document 1: JP 2008-130311 A

### SUMMARY OF THE INVENTION

### Problems to be Solved

However, in the above configuration, the creepage distance between the terminal fittings is thought to decrease near a connection surface with the connector and a mating connector connected. Thus, with the connector and the mating connector connected, it may be difficult to suppress a short circuit between the terminal fittings.

### Means to Solve the Problem

The present disclosure is directed to a connector with a plurality of terminals, a housing including a plurality of terminal accommodating portions for accommodating the terminals, the terminal accommodating portions being arranged in parallel in a width direction, and a retainer for retaining the terminals in the terminal accommodating portions, the housing being formed with a mounting hole communicating with the plurality of terminal accommodating portions, the retainer being mounted into the mounting hole, and a first recess disposed between the terminal accommodating portions adjacent in the width direction, the first recess being recessed rearward from a front surface of the housing, the first recess including a front recess penetrating through the housing in a front-rear direction from the front surface of the housing to a front end of the mounting hole and a rear recess extending further rearward than a rear end of the mounting hole, and the retainer being formed with a second recess penetrating through the retainer in the front-rear direction and communicating with the front recess and the rear recess with the retainer mounted in the mounting hole.

### Effect of the Invention

According to the present disclosure, it is possible to provide a technique for increasing a creepage distance between terminals in a connector.

### BRIEF DESCRIPTION OF THE DRAWINGS

FIG. 1 is a perspective view of a connector assembly according to an embodiment.

FIG. 2 is a perspective view of a connector.

FIG. 3 is a perspective view of a mating connector.

FIG. 4 is a perspective view of the connector showing a state where a retainer is not mounted.

FIG. 5 is a partial enlarged perspective view of the retainer in the connector.

FIG. 6 is a plan view of the connector.

FIG. 7 is a view in section along A-A of FIG. 6 showing the state where the retainer is not mounted.

FIG. 8 is a section along A-A of FIG. 6.

FIG. 9 is a section along B-B of FIG. 6.

FIG. 10 is a view in section along A-A of FIG. 6 showing a state where the connector and the mating connector are connected.

FIG. 11 is a view in section along B-B of FIG. 6 showing the state where the connector and the mating connector are connected.

FIG. 12 is a section along C-C of FIG. 10.

FIG. 13 is a section along D-D of FIG. 10.

FIG. 14 is an enlarged view of FIG. 12 showing a creepage distance between terminals near a mounting hole.

FIG. 15 is an enlarged view of FIG. 13 showing the creepage distance between the terminals near the mounting hole.

FIG. 16 is an enlarged section corresponding to FIG. 14 of a connector according to a comparative example showing a creepage distance between terminals near a mounting hole.

### DETAILED DESCRIPTION TO EXECUTE THE INVENTION

### Description of Embodiments of Present Disclosure

First, embodiments of the present disclosure are listed and described below.
(1) The connector of the present disclosure is provided with a plurality of terminals, a housing including a plurality of terminal accommodating portions for accommodating the terminals, the terminal accommodating portions being arranged in parallel in a width direction, and a retainer for retaining the terminals in the terminal accommodating portions, the housing being formed with a mounting hole communicating with the plurality of terminal accommodating portions, the retainer being mounted into the mounting hole, and a first recess disposed between the terminal accommodating portions adjacent in the width direction, the first recess being recessed rearward from a front surface of the housing, the first recess including a front recess penetrating through the housing in a front-rear direction from the front surface of the housing to a front end of the mounting hole and a rear recess extending further rearward than a rear end of the mounting hole, and the retainer being formed with a second recess penetrating through the retainer in the front-rear direction and communicating with the front recess and the rear recess with the retainer mounted in the mounting hole.

According to this configuration, since the connector is provided with the first and second recesses, a creepage distance between the terminals can be increased by connecting a mating connector including a separation wall to be accommodated into the first and second recesses.
(2) Preferably, the mounting hole is open upward, the terminal accommodating portion is formed with an opening open upward and communicating with the mounting hole, the terminal accommodating portion includes a side wall constituting the opening and facing the terminal in the width direction, the terminal includes a terminal body, a rear end part of the terminal body is disposed to be lockable by the retainer, an upper end part of the side wall is disposed nearly at the same height as an upper end part of the terminal body, the housing includes a connection wall disposed between the terminal accommodating portions adjacent in the width direction and connecting the side walls in the width direction, the connection wall is disposed below upper ends of the side walls, and the connection wall and the side walls constitute a third recess recessed downward.

According to this configuration, since the housing is provided with the third recess and the upper end parts of the side walls are disposed nearly at the same height as the upper end part of the terminal body, the creepage distance between the terminals can be increased on the periphery of the mounting hole of the retainer by accommodating the separation wall of the mating connector into the third recess.
(3) Preferably, the retainer is integrally formed to the housing via a hinge portion.

According to this configuration, the number of members constituting the connector can be reduced by integrally forming the retainer to the housing.
(4) A connector assembly of the present disclosure is provided with the above connector and a mating connector to be connected to the connector, the mating connector including a receptacle to be externally fit to the housing, a plurality of mating terminals to be disposed in the receptacle and connected to the terminals and a separation wall disposed between the mating terminals in the receptacle, and the separation wall being accommodated in the first recess and the second recess with the connector and the mating connector connected.

According to this configuration, creepage distances between the terminals and between the mating terminals can be increased by connecting the connector and the mating connector and accommodating the separation wall into the first and second recesses.

### Details of Embodiment of Present Disclosure

Hereinafter, an embodiment of the present disclosure is described. The present disclosure is not limited to these illustrations, but is represented by claims and intended to include all changes in the scope of claims and in the meaning and scope of equivalents.

### Embodiment

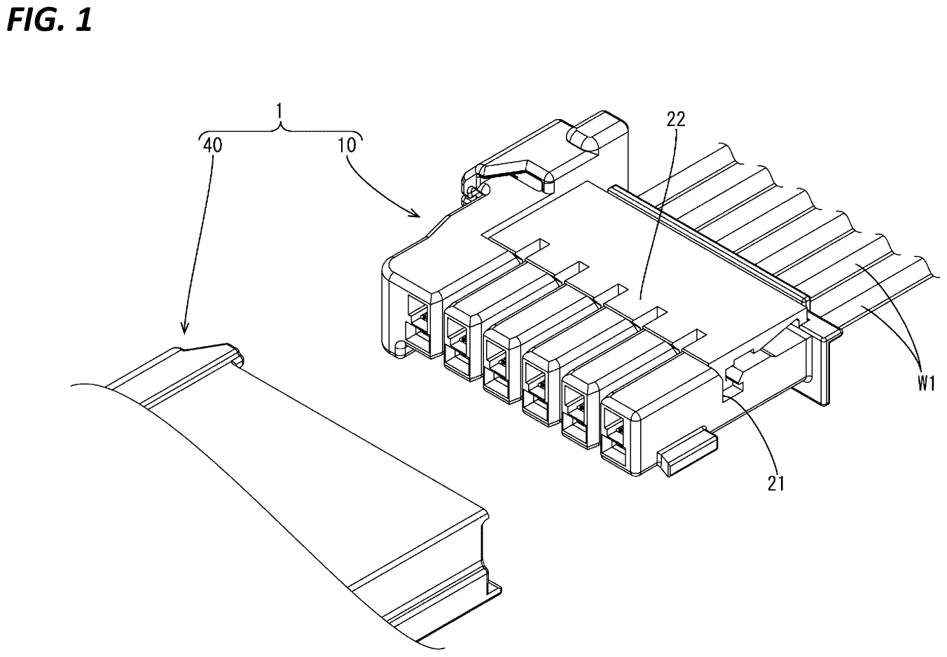

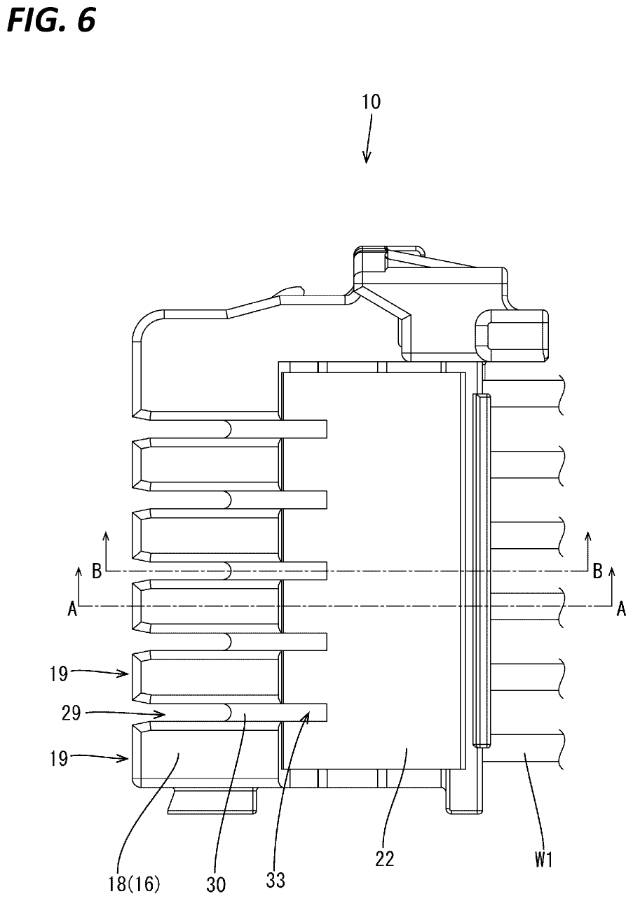

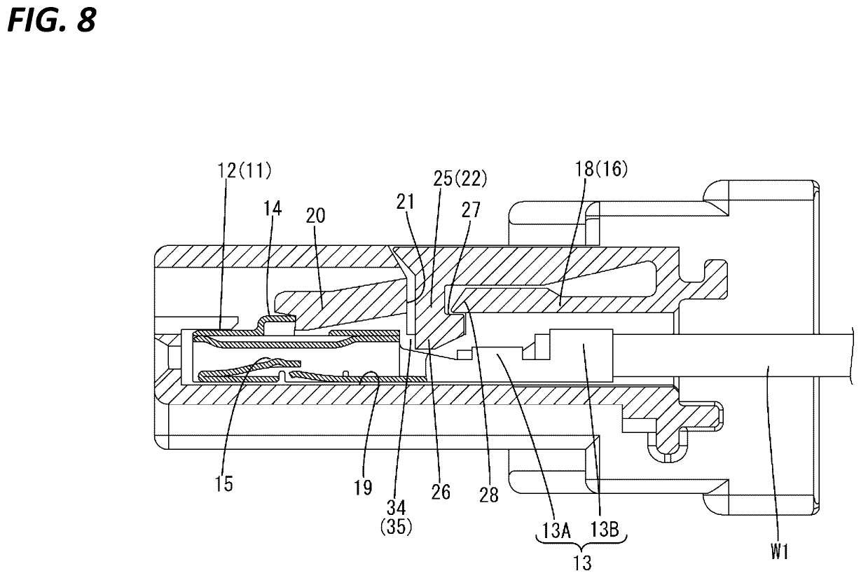

An embodiment of the present disclosure is described with reference to FIGS. 1 to 16. A connector assembly 1 according to this embodiment includes a connector 10 and a mating connector 40 to be connected to the connector 10 as shown in FIG. 1. In the following description, a front-rear direction is based on a connection direction of the connector 10 and the mating connector 40, and connection surface sides of these connectors are referred to as front sides. A vertical direction is based on FIG. 8. An upper side and a lower side in a plan view of FIG. 6 are referred to as a right side and a left side concerning a lateral direction (width direction). Note that, for a plurality of identical members, only some members may be denoted by a reference sign and the other members may not be denoted by the reference sign.

### Mating Connector

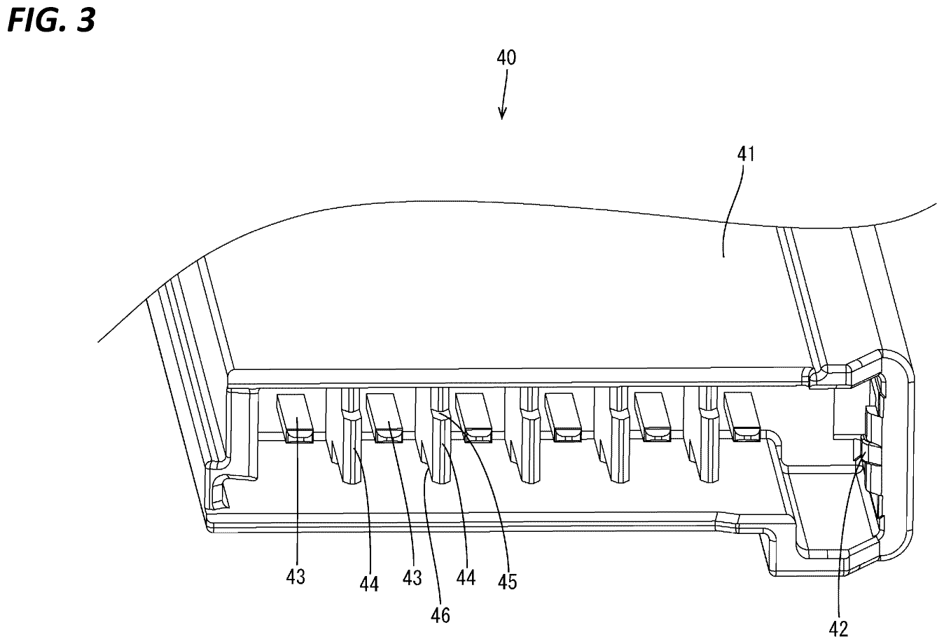

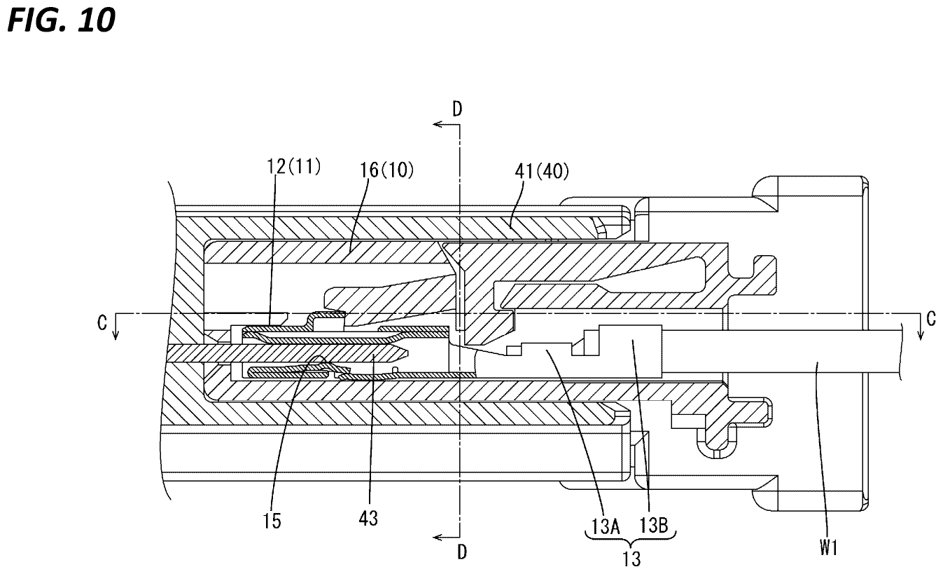

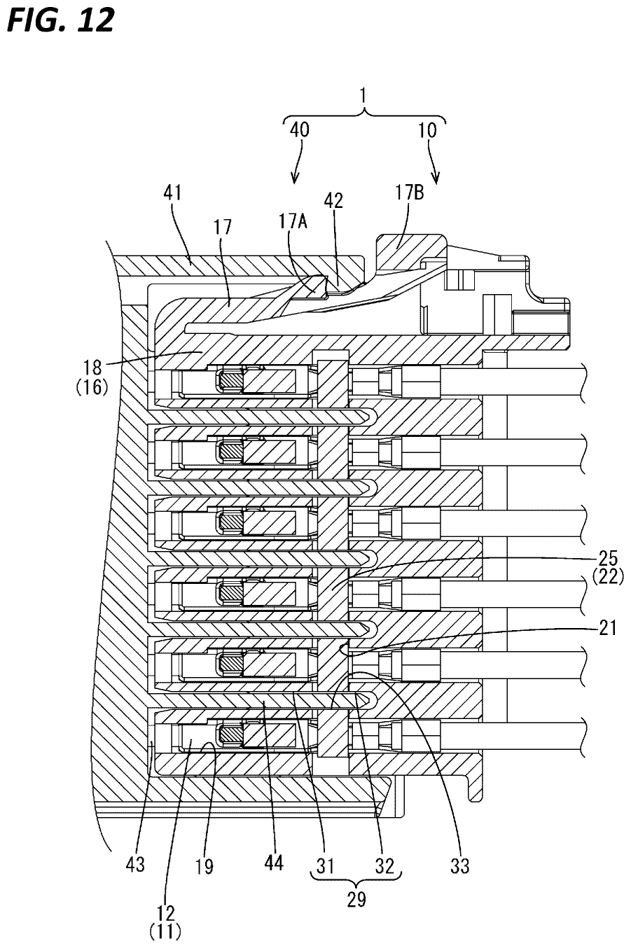

As shown in FIG. 3, the mating connector 40 is provided with a receptacle 41 open forward, a plurality of mating terminals 43 to be disposed in the receptacle 41 and separation walls 44 disposed between the mating terminals 43 in the receptacle 41. The mating terminal 43 is connected to an unillustrated wire, and this wire extends rearward of the mating connector 40. The receptacle 41 is made of insulating synthetic resin and box-shaped. A lock receiving portion 42 projecting inward of the receptacle 41 is provided on an inner wall on a right side of the receptacle 41. As shown in FIGS. 10 and 12, the receptacle 41 is externally fit to a housing 16 of the connector 10. As shown in FIG. 12, the lock receiving portion 42 is locked to a lock portion 17A of the connector 10.

### Separation Walls

As shown in FIG. 3, the mating terminal 43 is formed, such as by press-working a metal member and has a tab shape. The plurality of mating terminals 43 are arranged side by side in the width direction (lateral direction) in one stage in a height direction (vertical direction). The mating terminals 43 are held through the back wall of the receptacle 41 and project forward in the receptacle 41. The separation walls 44 are disposed between the mating terminals 43 adjacent in the width direction. The separation walls 44 are integrally formed to the receptacle 41. The separation walls 44 are provided to be continuous with the back wall, the upper wall and the lower wall of the receptacle 41. A first cut 45 and a second cut 46 respectively recessed rearward are formed on upper and lower sides of the separation wall 44. By providing the separation wall 44 between the mating terminals 43, a creepage distance between the mating terminals 43 can be increased.

### Connector

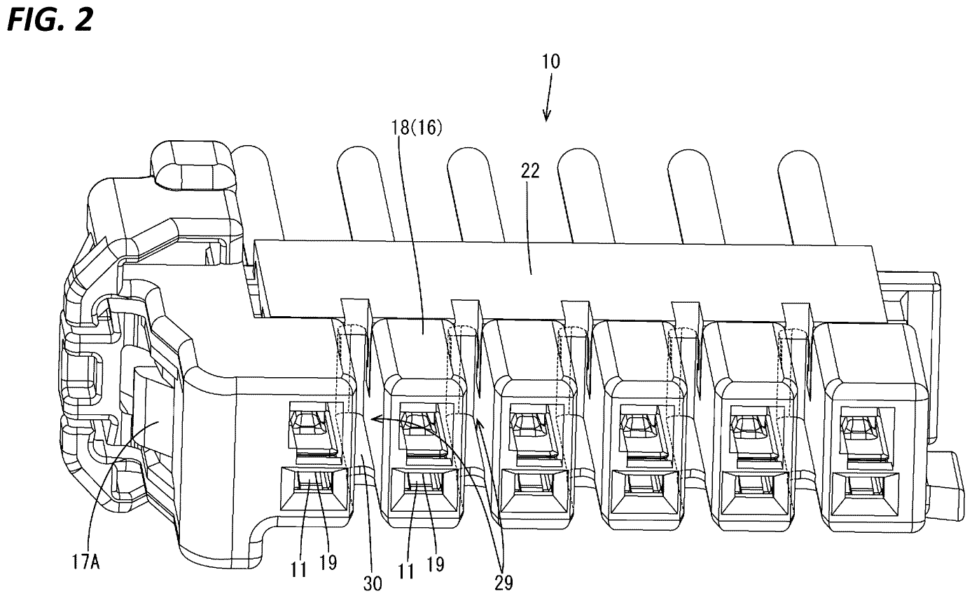

As shown in FIG. 2, the connector 10 is provided with a plurality of terminals 11, the housing 16 for accommodating the plurality of terminals 11 and a retainer 22 for retaining the terminals 11 in the housing 16.

### Terminal

The terminal 11 is formed, such as by press-working a metal member. As shown in FIG. 8, the terminal 11 is provided with a terminal body 12 and a wire connecting portion 13 connected behind the terminal body 12. The terminal body 12 is in the form of a rectangular tube. The terminal body 12 includes a locking portion 14 provided to project from an upper wall and a resilient contact piece 15 provided inside the terminal body 12. As shown in FIG. 10, if the mating terminal 43 is inserted into the terminal body 12, the mating terminal 43 and the resilient contact piece 15 contact. In this way, the terminal 11 and the mating terminal 43 are electrically connected. The wire connecting portion 13 includes a wire barrel portion 13A to be crimped to a core wire of a wire W1 and an insulation barrel portion 13B to be crimped to an insulation coating of the wire W1.

### Housing

The housing 16 is made of insulating synthetic resin and, as shown in FIG. 2, in the form of a block. As shown in FIG. 12, a lock arm 17 cantilevered rearward from a front end part of the housing 16 is provided on the right outer surface of the housing 16. The lock arm 17 includes the lock portion 17A to be locked to the lock receiving portion 42 of the mating connector 40. An operating portion 17B for releasing the locking of the lock portion 17A and the lock receiving portion 42 is provided on a rear end part of the lock arm 17.

### Terminal Accommodating Portions

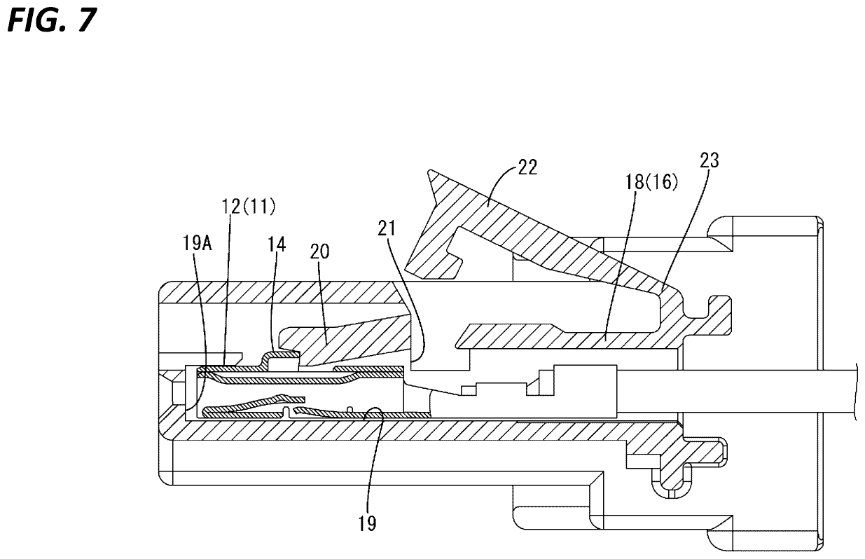

As shown in FIG. 2, the housing 16 is provided with a housing body 18 and a plurality of terminal accommodating portions 19 formed to penetrate through the housing body 18 in the front-rear direction. The plurality of terminal accommodating portions 19 are arranged side by side in the width direction (lateral direction) in one stage in the height direction (vertical direction). As shown in FIG. 7, the terminal 11 is inserted into the terminal accommodating portion 19 from behind. The terminal 11 contacts a front wall 19A of the terminal accommodating portion 19, thereby being restricted from moving forward. The upper wall of the housing 16 is provided with locking lances 20 which enter the terminal accommodating portions 19 and are resiliently deformable with respect to the housing body 18. The locking lance 20 restricts a rearward movement of the terminal 11 by being locked to the locking portion 14 of the terminal 11.

### Mounting Hole, Retainer

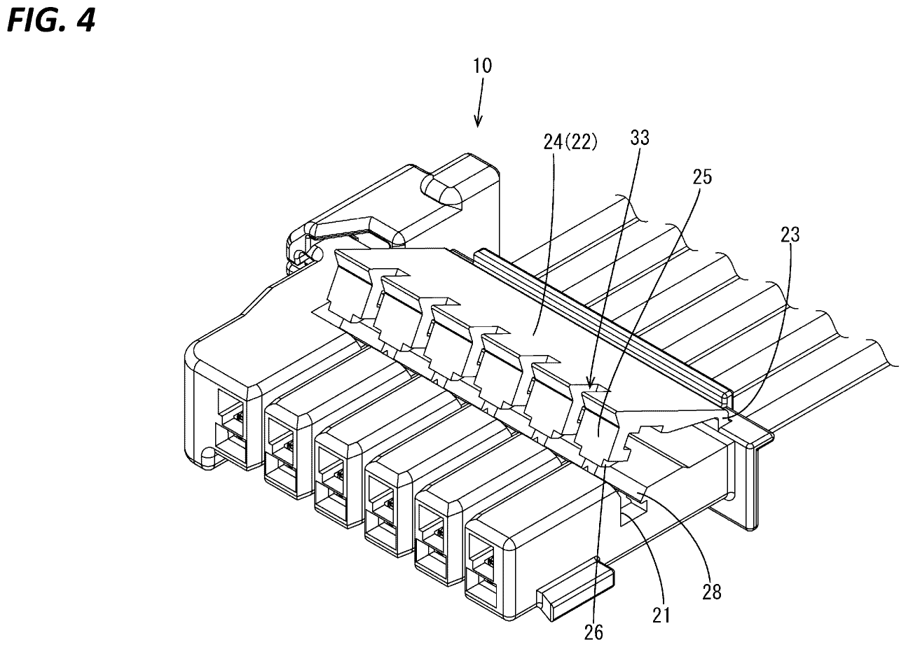

The housing 16 is formed with a mounting hole 21 open in the upper surface of the housing body 18 and communicating with the terminal accommodating portions 19. The retainer 22 is mounted into the mounting hole 21. The retainer 22 of this embodiment is integrally formed to the housing body 18. The retainer 22 is connected to a rear end part of an upper side of the housing body 18 via a hinge portion 23. The hinge portion 23 is formed to be thin and can be bent and deformed. The retainer 22 is configured to be openable and closable between an open state (see FIGS. 4 and 7) where the mounting hole 21 is open and a closed state (see FIGS. 1 and 8) where the retainer 22 is mounted in the mounting hole 21. As shown in FIG. 7, the terminals 11 are insertable into the terminal accommodating portions 19 from behind when the retainer 22 is in the open state. As shown in FIG. 8, the retainer 22 retains the terminals 11 in the terminal accommodating portions 19 when the retainer 22 is in the closed state.

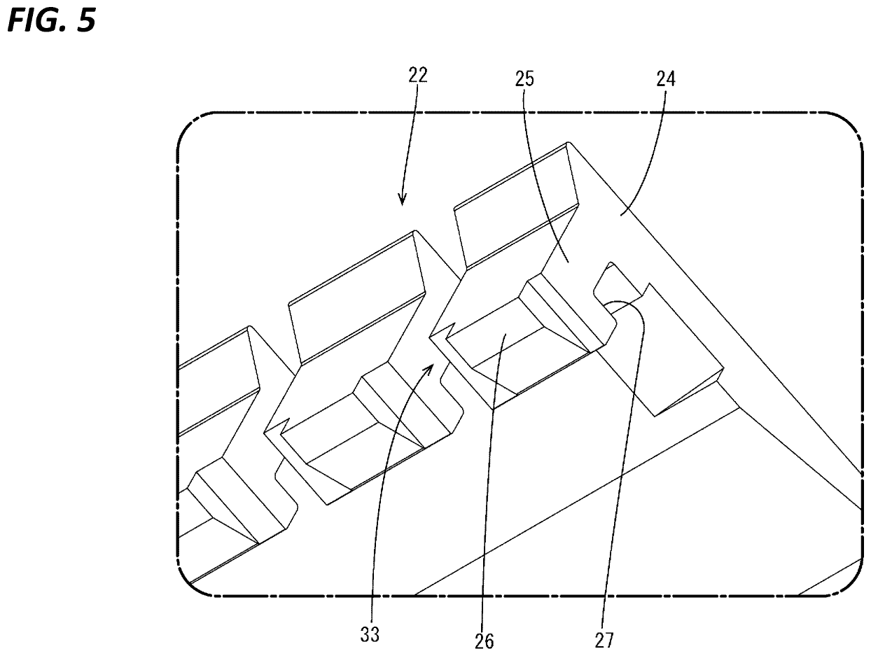

As shown in FIG. 4, the retainer 22 includes a plate-like lid portion 24 to be connected to the hinge portion 23, a projecting plate portion 25 extending from the lid portion 24 toward the mounting hole 21 and retaining portions 26 (see FIG. 5) projecting downward from the lower surface of the projecting plate portion 25. As shown in FIG. 8, the projecting plate portion 25 is disposed inside the mounting hole 21 when the retainer 22 is in the closed state. The retaining portion 26 enters the terminal accommodating portion 19 through an opening 34 to be described later and is disposed to be lockable to the terminal body 12 of the terminal 11 from behind. In this way, the terminal 11 is secondarily locked and retained not to come out rearward in the terminal accommodating portion 19.

As shown in FIG. 5, the retainer 22 includes a locking recess 27 recessed forward from the rear surface of the projecting plate portion 25. As shown in FIG. 8, the housing 16 includes a locking projection 28 projecting into the mounting hole 21 from a rear hole edge part of the mounting hole 21. The retainer 22 is held in the closed state by locking the locking projection 28 and the locking recess 27.

### First Recesses, Connection Walls

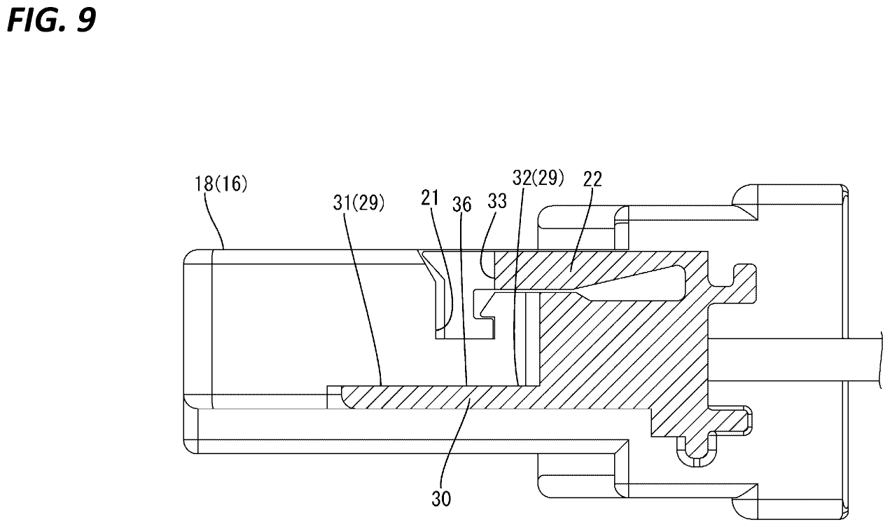

As shown in FIGS. 2 and 6, the housing 16 is formed with a plurality of first recesses 29 recessed rearward from the front surface of the housing body 18. The first recesses 29 are disposed between the terminal accommodating portions 19 adjacent in the width direction. Connection walls 30 connecting the terminal accommodating portions 19 in the width direction are provided on lower end parts of rear sides of the first recesses 29. By providing the connection walls 30, a reduction in the strength of the housing 16 due to the formation of the first recesses 29 can be suppressed. As shown in FIGS. 9 and 12, the first recess 29 communicates with the mounting hole 21. The first recess 29 includes a front recess 31 extending from the front surface of the housing body 18 to the front end of the mounting hole 21 and a rear recess 32 extending rearward from the rear end of the mounting hole 21.

### Second Recesses

As shown in FIG. 4, the retainer 22 includes second recesses 33 recessed rearward from front end parts of the lid portion 24 and the projecting plate portion 25. As shown in FIG. 5, the second recesses 33 penetrate through the projecting plate portion 25 in the front-rear direction. By providing the second recesses 23 in this way, the projecting plate portion 25 is easily deflected when the retainer 22 is inserted into the mounting hole 21 and the projecting plate portion 25 slides in contact with the inner wall of the mounting hole 21. Thus, the retainer 22 is easily mounted into the mounting hole 21. As shown in FIG. 12, when the retainer 22 is in the closed state, the second recesses 33 are disposed between the front recesses 31 and the rear recesses 32 and communicate with the front recesses 31 and the rear recesses 32.

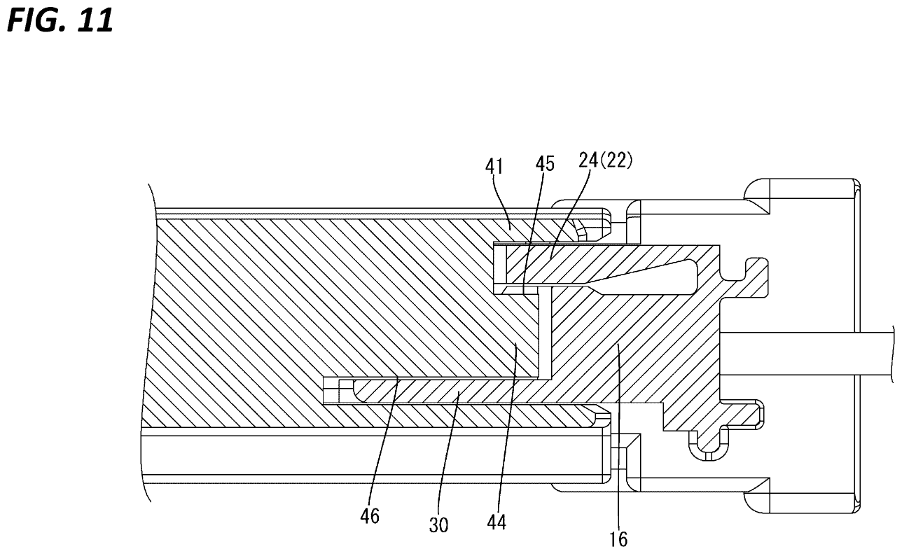

As shown in FIG. 12, the separation walls 44 are accommodated inside the first and second recesses 29, 33 with the connector 10 and the mating connector 40 connected. As shown in FIG. 11, the lid portion 24 of the retainer 22 enters the first cuts 45 of the separation walls 44. The connection walls 30 of the housing 16 enter the second cuts 46 of the separation walls 44.

### Creepage Distances Between Terminals in Horizontal Cross-Section of Connector According to Comparative Example

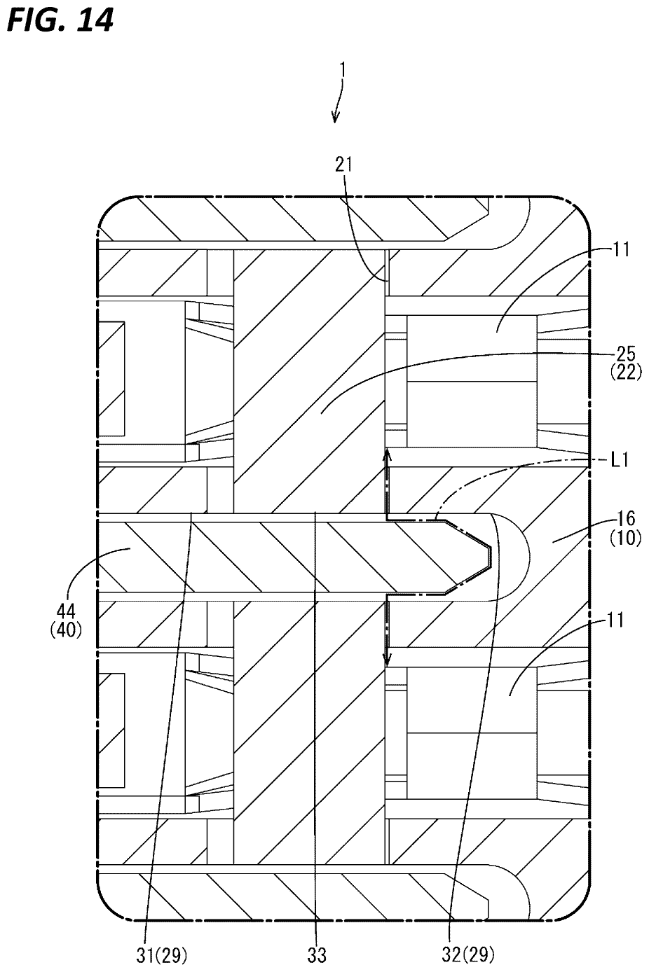

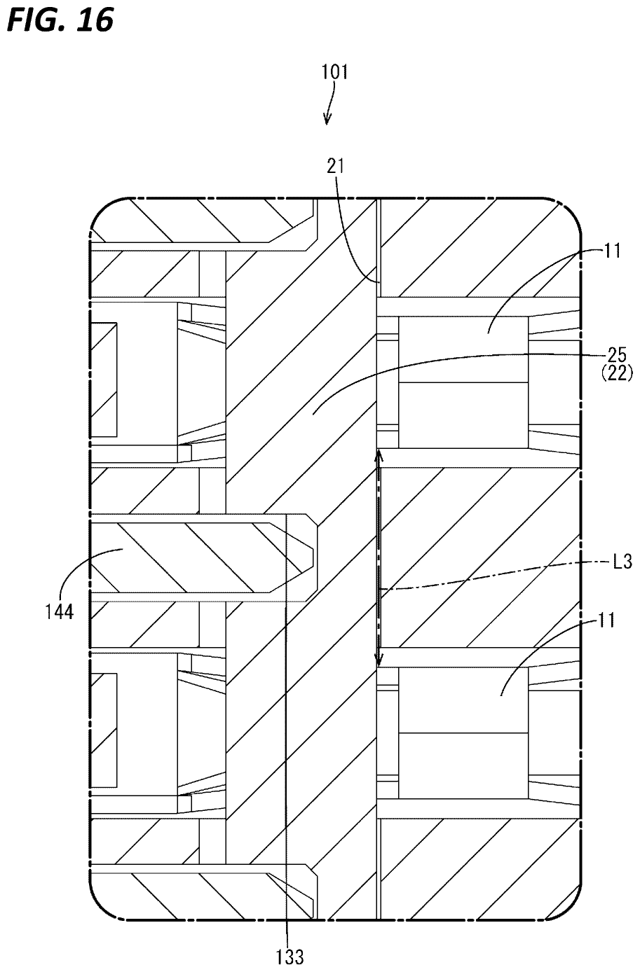

Since the mounting hole 21, into which the retainer 22 is mounted, is provided to communicate with the terminal accommodating portions 19, creepage distances between the terminals 11 may decrease on the periphery of the mounting hole 21. For example, FIG. 16 is an enlarged horizontal section of a connector assembly 101 according to a comparative example not included in the scope of the present disclosure and shows a region corresponding to FIG. 14. As shown in FIG. 16, a retainer 22 is provided with recesses 133 instead of the second recesses 33. The recess 133 is recessed rearward from a front end part of a projecting plate portion 25, but does not penetrate through the projecting plate portion 25 in the front-rear direction. A separation wall 144 is disposed inside the recess 133. A tip part of the separation wall 144 does not project rearward of the projecting plate portion 25. Thus, in this connector assembly 101, a creepage distance L3 (one-dot chain line of FIG. 16) between terminals 11 is short on the rear end of the mounting hole 21. This creepage distance L3 between the terminals 11 is equal to a distance between the terminals 11 in the width direction.

### Creepage Distances Between Terminals in Horizontal Cross-Section of Connector

On the other hand, in this embodiment, the separation walls 44 are disposed in the second recesses 33 penetrating through the retainer 22 in the front-rear direction and tip parts of the separation walls 44 are disposed in the rear recesses 32 of the first recesses 29 with the connector 10 and the mating connector 40 connected as shown in FIG. 14. In this way, a creepage distance L1 (one-dot chain line of FIG. 14) between the terminals 11 in a horizontal cross-section (here, cross-section parallel to a horizontal plane) including the connection direction of the connector 10 and the mating connector 40 is larger than that in the comparative example by as much as the separation wall 44 projects further rearward than the projecting plate portion 25.

### Opening

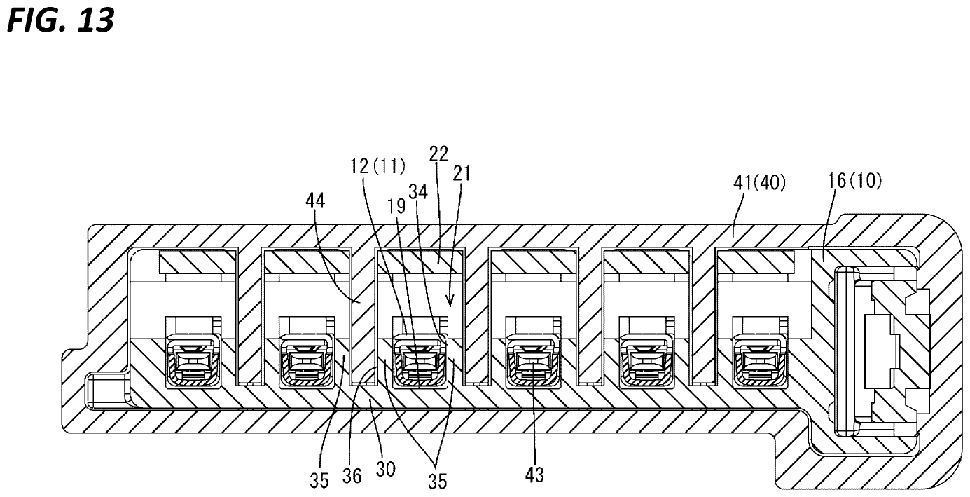

As shown in FIG. 13, the terminal accommodating portion 19 includes an opening 34 communicating with the mounting hole 21. The opening 34 is provided in an upper part of the terminal accommodating portion 19 and open upward. As shown in FIG. 8, the opening 34 can receive the retaining portion 26 of the retainer 22 and the retainer 26 can lock a rear end part of the terminal body 12.

### Side Walls, Third Recesses

As shown in FIG. 13, the terminal accommodating portion 19 includes two side walls 35 constituting the opening 34. The side walls 35 are facing the terminal 11 in the width direction. Upper end parts of the side walls 35 are disposed nearly at the same height as an upper end part of the terminal body 12. The connection wall 30 is disposed between the terminal accommodating portions 19 adjacent in the width direction and connects the side walls 35 in the width direction. An upper end part of the connection wall 30 is disposed below the upper end parts of the side walls 35. The upper end part of the connection wall 30 is disposed nearly at the same height as a lower end part of the terminal body 12. In this way, the housing 16 includes third recesses 36 constituted by the side walls 35 and the connection wall 30. The third recess 36 is recessed downward from the upper end parts of the side walls 35 and is disposed between the terminal accommodating portions 19 adjacent in the width direction. As shown in FIG. 9, the third recess 36 communicates with the first and second recesses 29, 33.

### Creepage Distances between Terminals in Vertical Cross-Section of Connector

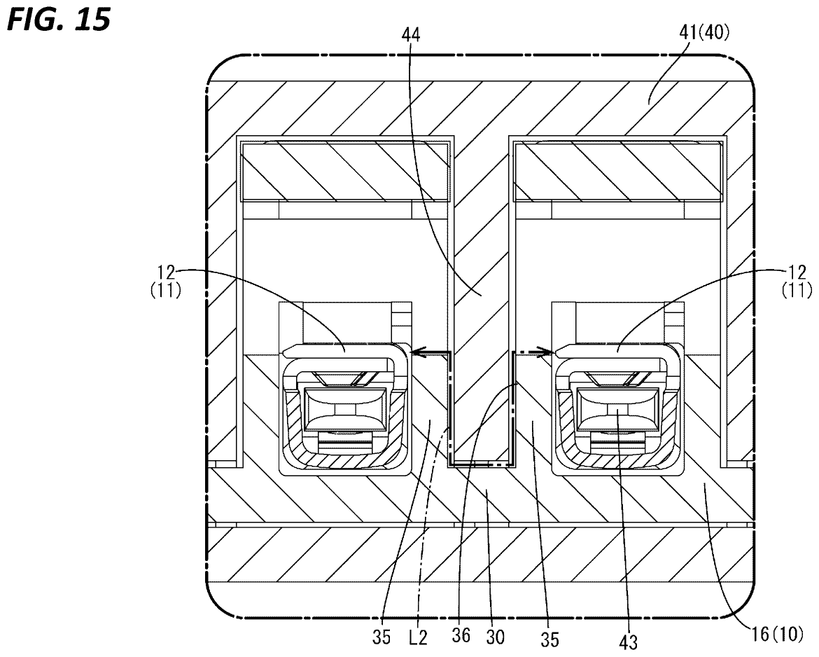

With the connector 10 and the mating connector 40 connected, the separation walls 44 are disposed in the third recesses 36 as shown in FIG. 13. In this embodiment, the upper end parts of the side walls 35 are disposed nearly at the same height as the upper end parts of the terminal bodies 12. Accordingly, as shown in FIG. 15, a creepage distance L2 (one-dot chain line of FIG. 15) between the terminals 11 in a vertical cross-section (plane perpendicular to the connection direction of the connector 10 and the mating connector 40) is larger than the distance between the terminals 11 in the width direction.

As described above, according to the configuration of this embodiment, the creepage distance L1 between the terminals in the horizontal cross-section and the creepage distance L2 between the terminals 11 in the vertical cross-section can be increased with the connector 10 and the mating connector 40 connected. Therefore, in the case of using the connector assembly 1 of this embodiment in oil such as lubricating oil containing foreign matters such as iron powders, short circuits between the terminals 11 due to the foreign mattes can be suppressed.

### Functions and Effects of Embodiment

According to the embodiment, the following functions and effects are achieved.

The connector 10 according to the embodiment is provided with the plurality of terminals 11, the housing 16 including the plurality of terminal accommodating portions 19 configured to accommodate the terminals 11 and arranged in parallel in the width direction, and the retainer 22 for retaining the terminals 11 in the terminal accommodating portions 19. The housing 16 is formed with the mounting hole 21 communicating with the plurality of terminal accommodating portions 19, the retainer 22 being mounted into the mounting hole 21, and the first recesses 29 disposed between the terminal accommodating portions 19 adjacent in the width direction and recessed rearward from the front surface of the housing 16. The first recess 29 includes the front recess 31 penetrating through the housing 16 in the front-rear direction from the front surface of the housing 16 to the front end of the mounting hole 21 and the rear recess 32 extending further rearward than the rear end of the mounting hole 21. The retainer 22 is formed with the second recesses 33 penetrating through the retainer 22 in the front-rear direction and communicating with the front and rear recesses 31, 32 with the retainer 22 mounted in the mounting hole 21.

According to this configuration, since the connector 10 is provided with the first recesses 29 and the second recesses 33, the creepage distances between the terminals 11 can be increased by connecting the mating connector 40 including the separation walls 44 to be accommodated into the first recesses 29 and the second recesses 33.

In the embodiment, the mounting hole 21 is open upward, the terminal accommodating portion 19 is formed with the opening 34 open upward and communicating with the mounting hole 21, the terminal accommodating portion 19 includes the side walls 35 constituting the opening 34 and facing the terminal 11 in the width direction, the terminal 11 includes the terminal body 12, the rear end part of the terminal body 12 is disposed to be lockable by the retainer 22, the upper end parts of the side walls 35 are disposed nearly at the same height as the upper end part of the terminal body 12, the housing 16 is provided with the connection walls 30 disposed between the terminal accommodating portions 19 adjacent in the width direction and connecting the side walls 35 in the width direction, the connection wall 30 is disposed below the upper ends of the side walls 35, and the connection wall 30 and the side walls 35 constitute the third recess 36 recessed downward.

According to this configuration, since the housing 16 is provided with the third recess 36 and the upper end parts of the side walls 35 are disposed nearly at the same height as the upper end part of the terminal body 12, the separation wall 44 of the mating connector 40 is accommodated into the third recess 36, whereby the creepage distance between the terminals 11 on the periphery of the mounting hole 21 of the retainer 22 can be increased.

In the embodiment, the retainer 22 is integrally formed to the housing 16 via the hinge portion 23.

According to this configuration, the number of members constituting the connector 10 can be reduced by integrally forming the retainer 22 to the housing 16.

The connector assembly 1 of the embodiment is provided with the connector 10 and the mating connector 40 to be connected to the connector 10, the mating connector 40 includes the receptacle 41 to be externally fit to the housing 16, the plurality of mating terminals 43 disposed in the receptacle 41 and to be connected to the terminals 11 and the separation walls 44 disposed between the mating terminals 43 in the receptacle 41, and the separation walls 44 are accommodated into the first recesses 29 and the second recesses 33 with the connector 10 and the mating connector 40 connected.

According to this configuration, the creepage distances between the terminals 11 and between the mating terminals 43 can be increased by connecting the connector 10 and the mating connector 40 and accommodating the separation walls 44 into the first recesses 29 and the second recesses 33.

### Other Embodiments

(1) Although the retainer 22 is integrally formed to the housing 16 in the above embodiment, there is no limitation to this and a retainer may be separate from a housing.
(2) Although the housing 16 includes the plurality of terminal accommodating portions 19 arranged in one stage in the height direction in the above embodiment, there is no limitation to this and a housing may include a plurality of terminal accommodating portions arranged in two stages in a height direction.

### LIST OF REFERENCE NUMERALS

1: connector assembly
10: connector
11: terminal
12: terminal body
13: wire connecting portion
13A: wire barrel portion
13B: insulation barrel portion
14: locking portion
15: resilient contact piece
16: housing
17: lock arm
17A: lock portion
17B: operating portion
18: housing body
19: terminal accommodating portion
19A: front wall
20: locking lance
21: mounting hole
22: retainer
23: hinge portion
24: lid portion
25: projecting plate portion
26: retaining portion
27: locking recess
28: locking projection
29: first recess
30: connection wall
31: front recess
32: rear recess
33: second recess
34: opening
35: side wall
36: third recess
40: mating connector
41: receptacle
42: lock receiving portion
43: mating terminal
44: separation wall
45: first cut
46: second cut
101: connector assembly according to comparative example
133: recess according to comparative example
144: separation wall according to comparative example
L1 creepage distance between terminals in horizontal cross-section
L2 creepage distance between terminals in vertical cross-section
L3 creepage distance between terminals in horizontal cross-section according to comparative example
W1: wire

1. A connector, comprising:
a plurality of terminals;
a housing including a plurality of terminal accommodating portions for accommodating the terminals, the terminal accommodating portions being arranged in parallel in a width direction; and
a retainer for retaining the terminals in the terminal accommodating portions,
the housing being formed with a mounting hole communicating with the plurality of terminal accommodating portions, the retainer being mounted into the mounting hole, and a first recess disposed between the terminal accommodating portions adjacent in the width direction, the first recess being recessed rearward from a front surface of the housing;
the first recess including a front recess penetrating through the housing in a front-rear direction from the front surface of the housing to a front end of the mounting hole and a rear recess extending further rearward than a rear end of the mounting hole, and
the retainer being formed with a second recess penetrating through the retainer in the front-rear direction and communicating with the front recess and the rear recess with the retainer mounted in the mounting hole.

2. The connector of claim 1, wherein:
the mounting hole is open upward,
the terminal accommodating portion is formed with an opening open upward and communicating with the mounting hole,
the terminal accommodating portion includes a side wall constituting the opening and facing the terminal in the width direction,
the terminal includes a terminal body,
a rear end part of the terminal body is disposed to be lockable by the retainer,
an upper end part of the side wall is disposed nearly at the same height as an upper end part of the terminal body,
the housing includes a connection wall disposed between the terminal accommodating portions adjacent in the width direction and connecting the side walls in the width direction,
the connection wall is disposed below upper ends of the side walls, and
the connection wall and the side walls constitute a third recess recessed downward.

3. The connector of claim 1, wherein the retainer is integrally formed to the housing via a hinge portion.

4. A connector assembly, comprising:
the connector of claim 1;
a mating connector to be connected to the connector,
the mating connector including a receptacle to be externally fit to the housing, a plurality of mating terminals to be disposed in the receptacle and connected to the terminals, and a separation wall disposed between the mating terminals in the receptacle, and
the separation wall being accommodated in the first recess and the second recess with the connector and the mating connector connected.
